(19) United States
(12) Patent Application Publication
(10) Pub. No.: US 2024/0293992 A1
(43) Pub. Date: Sep. 5, 2024

(54) METHODS FOR MANUFACTURING SHELLS WITH STIFFENING GRID STRUCTURES

(71) Applicant: General Electric Company, Schenectady, NY (US)

(72) Inventor: James Robert Tobin, Greenville, SC (US)

(21) Appl. No.: 17/768,619

(22) PCT Filed: Oct. 15, 2019
(86) PCT No.: PCT/US2019/056188

§ 371 Date: Apr. 13, 2022

(51) Int. Cl. B32B 3/12; B29D 99/00; B29K 105/08; B32B 1/00; B32B 5/02; B32B 27/30; B32B 27/36; F03D 1/06

(52) U.S. Cl. CPC B32B 3/12; B29D 99/0028; B32B 1/00; B32B 5/02; B32B 27/308; B32B 27/365; B29K 2105/08; B32B 2260/021; B32B 2260/046; B32B 2603/00; F03D 1/0675

(57) ABSTRACT

A method for manufacturing a shell includes providing a mold of the shell. The method also includes forming one or more first skins on the mold. Further, the method includes securing at least one three-dimensional (3-D) grid structure onto an inner surface of the one or more first skins. Thus, the method also includes securing one or more reinforcing members to one or more locations of the grid structure so as to locally increase a stiffness of the shell at the one or more locations by creating one or more localized sandwich structures with the grid structure.

### FIELD

The present disclosure relates in general to wind turbine rotor blades, and more particularly to methods of manufacturing shells having stiffening grid structures, for example, for wind turbine rotor blades.

### BACKGROUND

Wind power is considered one of the cleanest, most environmentally friendly energy sources presently available, and wind turbines have gained increased attention in this regard. A modern wind turbine typically includes a tower, a generator, a gearbox, a nacelle, and one or more rotor blades. The rotor blades capture kinetic energy of wind using known foil principles. The rotor blades transmit the kinetic energy in the form of rotational energy so as to turn a shaft coupling the rotor blades to a gearbox, or if a gearbox is not used, directly to the generator. The generator then converts the mechanical energy to electrical energy that may be deployed to a utility grid.

The rotor blades generally include a suction side shell and a pressure side shell typically formed using molding processes that are bonded together at bond lines along the leading and trailing edges of the blade. Further, the pressure and suction shells are relatively lightweight and have structural properties (e.g., stiffness, buckling resistance and strength) which are not configured to withstand the bending moments and other loads exerted on the rotor blade during operation. Thus, to increase the stiffness, buckling resistance and strength of the rotor blade, the body shell is typically reinforced using one or more exterior structural components (e.g. opposing spar caps with a shear web configured therebetween) that engage the inner pressure and suction side surfaces of the shell halves.

The spar caps are typically constructed of various materials, including but not limited to glass fiber laminate composites and/or carbon fiber laminate composites. The shell of the rotor blade is generally built around the spar caps of the blade by stacking layers of fiber fabrics in a shell mold. The layers are then typically infused together, e.g. with a thermoset resin. Accordingly, conventional rotor blades generally have a sandwich panel configuration. As such, conventional blade manufacturing of large rotor blades involves high labor costs, slow through put, and low utilization of expensive mold tooling. Further, the blade molds can be expensive to customize.

Thus, methods for manufacturing rotor blades may include forming the rotor blades in segments. The blade segments may then be assembled to form the rotor blade. For example, some modern rotor blades, such as those blades described in U.S. patent application Ser. No. 14/753,137 filed Jun. 29, 2015 and entitled “Modular Wind Turbine Rotor Blades and Methods of Assembling Same,” which is incorporated herein by reference in its entirety, have a modular panel configuration. Thus, the various blade components of the modular blade can be constructed of varying materials based on the function and/or location of the blade component.

In view of the foregoing, the art is continually seeking improved methods for manufacturing shells having stiffening grid structures, for example, for wind turbine rotor blades.

### BRIEF DESCRIPTION

Aspects and advantages of the invention will be set forth in part in the following description, or may be obvious from the description, or may be learned through practice of the invention.

In one aspect, the present disclosure is directed to a method for manufacturing a shell, such as a shell of a rotor blade. The method includes providing a mold of the shell. The method also includes forming one or more first skins on the mold. Further, the method includes securing at least one three-dimensional (3-D) grid structure onto an inner surface of the one or more first skins. Further, the method includes securing one or more reinforcing members to one or more locations of the grid structure so as to locally increase a stiffness of the shell at the one or more locations by creating one or more localized sandwich structures with the grid structure.

In an embodiment, securing the 3-D grid structure onto the inner surface of the first skin(s) may include placing the mold of the shell relative to a computer numeric control (CNC) device and printing and depositing, via the CNC device, a plurality of rib members that form the grid structure onto the inner surface of the first skin(s) before the one or more first skins have cooled from forming. As such, the grid structure bonds to the first skin(s) as the grid structure is being deposited.

In another embodiment, the location(s) of the reinforcing members may correspond to a center location of the shell, a trailing edge of the shell, and/or one or more locations having a load above a predetermined threshold. In further embodiments, determining the location(s) having the load above the predetermined threshold may include performing, for example, a computer-implemented structural analysis on the shell.

In several embodiments, securing the 3-D grid structure(s) onto the inner surface of the first skin(s) may include forming the grid structure of a core material and securing the grid structure to the inner surface of the first skin(s).

In particular embodiments, securing the one or more reinforcing members to one or more locations of the grid structure may include securing the one or more reinforcing members to a core material and securing at least a portion of the reinforcing member(s) and/or the core material to the inner surface of the first skin(s).

In further embodiments, the method may include securing the reinforcing member(s) to the location(s) of the grid structure via at least one of adhesive bonding, thermoplastic welding, ultrasonic welding, tack welding, laser welding, chemical welding, hot plate welding, and/or combinations thereof. In additional embodiments, the reinforcing member(s) may be constructed of at least one of laminate, polymer, metal, wood, fibers, and/or combinations thereof.

In another embodiment, the method may include bonding one or more second skins to at least one of the one or more reinforcing members of the one or more first skins. In such embodiments, the method may also include securing at least a portion of the grid structure to at least one of the one or more first skins or the one or more second skins.

In another aspect, the present disclosure is directed to a shell. The shell includes one or more fiber-reinforced first skins and at least one shell reinforcement assembly secured to the fiber-reinforced first skin(s). The shell reinforcement assembly includes at least one three-dimensional (3-D) grid structure and one or more reinforcing members secured to one or more locations of the grid structure so as to locally increase a stiffness of the shell at the one or more locations by creating one or more localized sandwich structures with the grid structure. It should be understood that the shell may further include any of the additional features described herein.

In yet another aspect, the present disclosure is directed to a method for manufacturing a shell. The method includes forming one or more fiber-reinforced first and second skins, such as via vacuum forming or additive manufacturing. The method also includes providing and heating a mold. Further, the method includes placing one or more reinforcing members on the heated mold. Moreover, the method includes printing and depositing, via the CNC device, a plurality of rib members that form the grid structure onto an inner surface of the one or more reinforcing members while the one or more reinforcing members are heated. As such, the grid structure bonds to the reinforcing member(s) as the grid structure is being deposited so as to form a shell reinforcement assembly. In addition, the method includes securing the shell reinforcement assembly between the one or more fiber-reinforced first and second skins. It should be understood that the method may further include any of the additional steps and/or features described herein.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1 illustrates a perspective view of one embodiment of a wind turbine according to the present disclosure;

FIG. 2 illustrates a perspective view of one embodiment of a rotor blade of a wind turbine according to the present disclosure;

FIG. 3 illustrates an exploded view of the modular rotor blade of FIG. 2;

FIG. 4 illustrates a cross-sectional view of one embodiment of a leading edge segment of a modular rotor blade according to the present disclosure;

FIG. 5 illustrates a cross-sectional view of one embodiment of a trailing edge segment of a modular rotor blade according to the present disclosure;

FIG. 6 illustrates a cross-sectional view of the modular rotor blade of FIG. 2 according to the present disclosure;

FIG. 7 illustrates a cross-sectional view of the modular rotor blade of FIG. 2 according to the present disclosure;

FIG. 8 illustrates a flow diagram of one embodiment of a method for manufacturing a rotor blade shell according to the present disclosure;

FIG. 9 illustrates a side view of one embodiment of a mold of a rotor blade shell according to the present disclosure, particularly illustrating a plurality of grid structures with reinforcing members secured thereto;

FIG. 10 illustrates a partial, side view of one embodiment of a rotor blade shell according to the present disclosure, particularly illustrating a grid structure having a reinforcing member secured to a core material;

FIG. 11 illustrates a perspective view of one embodiment of a grid structure according to the present disclosure;

FIG. 12 illustrates a cross-sectional view of one embodiment of a grid structure according to the present disclosure;

FIG. 13 illustrates a perspective view of another embodiment of a grid structure according to the present disclosure;

FIG. 14 illustrates a perspective view of one embodiment of a mold having with a three-dimensional printer positioned above the mold so as to print a grid structure thereto according to the present disclosure;

FIG. 15 illustrates a perspective view of one embodiment of a mold having a three-dimensional printer positioned above the mold and printing an outline of a grid structure thereto according to the present disclosure;

FIG. 16 illustrates a perspective view of one embodiment of a mold having a three-dimensional printer positioned above the mold and printing a grid structure thereto according to the present disclosure;

FIG. 17 illustrates a flow diagram of another embodiment of a method for manufacturing a shell according to the present disclosure; and

FIG. 18 illustrates a schematic diagram of one embodiment of a shell reinforcement assembly for a rotor blade shell being manufactured according to the present disclosure.

### DETAILED DESCRIPTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

Generally, the present disclosure is directed to methods for manufacturing grid structures for shells, such as wind turbine rotor blade shells using automated deposition of materials via technologies such as 3-D Printing, additive manufacturing, automated fiber deposition, as well as other techniques that utilize CNC control and multiple degrees of freedom to deposit material. In addition, the grid structures can be further reinforced with additional reinforcing members secured thereto, which provide additional structural stiffness at certain locations. As such, the grid structures of the present disclosure are useful for reinforcing such shells. The grid shape can also be optimized for maximum buckling load factor versus weight and print speed. Further, additive manufacturing allows for more customized reinforcement compared to conventional sandwich panels.

Thus, the methods described herein provide many advantages not present in the prior art. For example, the methods of the present disclosure provide the ability to easily customize shells having various curvatures, aerodynamic characteristics, strengths, stiffness, etc. As such, where the shells are used in rotor blade shells, the grid structures of the present disclosure can be designed to match the stiffness and/or buckling resistance of existing sandwich panels for rotor blades. More specifically, in certain embodiments, the shells of the present disclosure can be more easily customized based on the local buckling resistance needed. Still further advantages include the ability to locally and temporarily buckle to reduce loads and/or tune the resonant frequency of the rotor blade shells to avoid problem frequencies. Moreover, the grid structures described herein can be manufactured with less fiber reinforcement as the fiber may no longer necessary due to the additional laminate material.

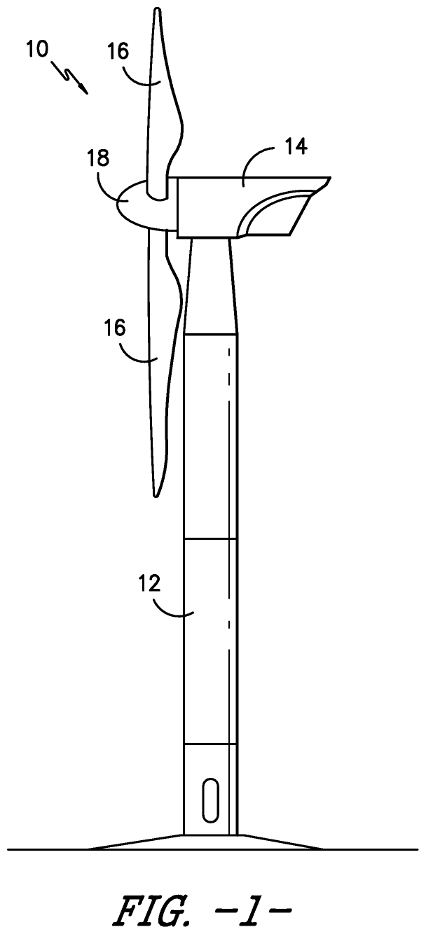

Referring now to the drawings, FIG. 1 illustrates one embodiment of a wind turbine 10 according to the present disclosure. As shown, the wind turbine 10 includes a tower 12 with a nacelle 14 mounted thereon. A plurality of rotor blades 16 are mounted to a rotor hub 18, which is in turn connected to a main flange that turns a main rotor shaft. The wind turbine power generation and control components are housed within the nacelle 14. The view of FIG. 1 is provided for illustrative purposes only to place the present invention in an exemplary field of use. It should be appreciated that the invention is not limited to any particular type of wind turbine configuration. In addition, the present invention is not limited to use with wind turbines, but may be utilized in any application having rotor blades. Further, the methods described herein may also apply to manufacturing any similar structure that benefits from printing a structure directly to skins within a mold before the skins have cooled so as to take advantage of the heat from the skins to provide adequate bonding between the printed structure and the skins. As such, the need for additional adhesive or additional curing is eliminated.

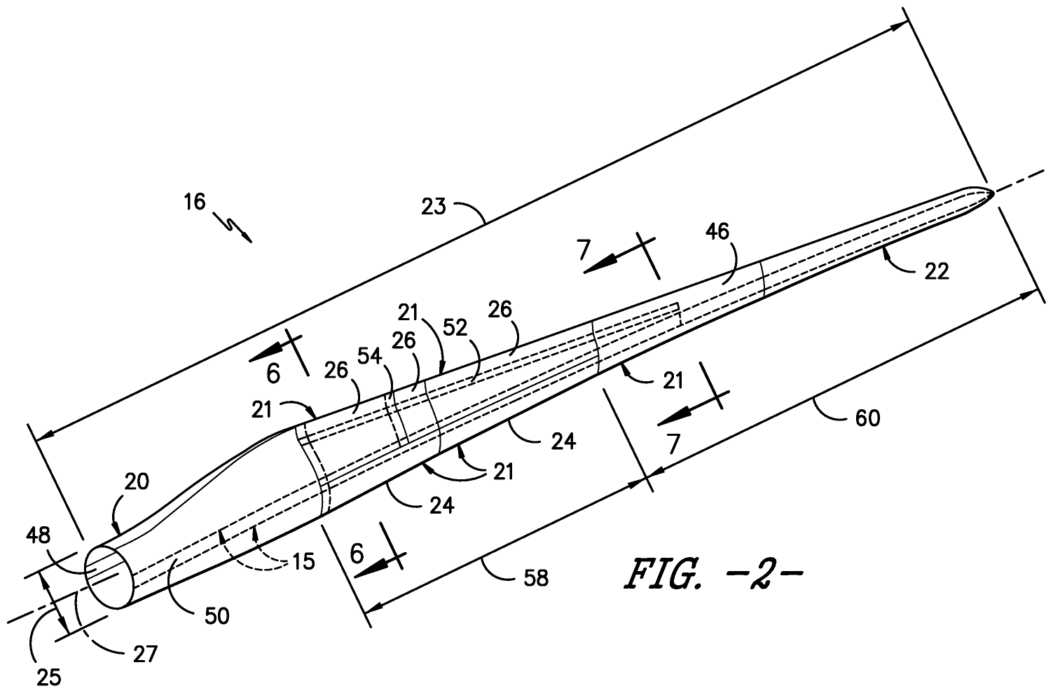

Referring now to FIGS. 2 and 3, various views of a rotor blade 16 according to the present disclosure are illustrated. As shown, the illustrated rotor blade 16 has a segmented or modular configuration. It should also be understood that the rotor blade 16 may include any other suitable configuration now known or later developed in the art. As shown, the modular rotor blade 16 includes a main blade structure 15 constructed, at least in part, from a thermoset and/or a thermoplastic material and at least one blade segment 21 configured with the main blade structure 15. More specifically, as shown, the rotor blade 16 includes a plurality of blade segments 21. The blade segment(s) 21 may also be constructed, at least in part, from a thermoset and/or a thermoplastic material.

The thermoplastic rotor blade components and/or materials as described herein generally encompass a plastic material or polymer that is reversible in nature. For example, thermoplastic materials typically become pliable or moldable when heated to a certain temperature and returns to a more rigid state upon cooling. Further, thermoplastic materials may include amorphous thermoplastic materials and/or semi-crystalline thermoplastic materials. For example, some amorphous thermoplastic materials may generally include, but are not limited to, styrenes, vinyls, cellulosics, polyesters, acrylics, polysulphones, and/or imides. More specifically, exemplary amorphous thermoplastic materials may include polystyrene, acrylonitrile butadiene styrene (ABS), polymethyl methacrylate (PMMA), glycolised polyethylene terephthalate (PET-G), polycarbonate, polyvinyl acetate, amorphous polyamide, polyvinyl chlorides (PVC), polyvinylidene chloride, polyurethane, or any other suitable amorphous thermoplastic material. In addition, exemplary semi-crystalline thermoplastic materials may generally include, but are not limited to polyolefins, polyamides, fluropolymer, ethyl-methyl acrylate, polyesters, polycarbonates, and/or acetals. More specifically, exemplary semi-crystalline thermoplastic materials may include polybutylene terephthalate (PBT), polyethylene terephthalate (PET), polypropylene, polyphenyl sulfide, polyethylene, polyamide (nylon), polyetherketone, or any other suitable semi-crystalline thermoplastic material.

Further, the thermoset components and/or materials as described herein generally encompass a plastic material or polymer that is non-reversible in nature. For example, thermoset materials, once cured, cannot be easily remolded or returned to a liquid state. As such, after initial forming, thermoset materials are generally resistant to heat, corrosion, and/or creep. Example thermoset materials may generally include, but are not limited to, some polyesters, some polyurethanes, esters, epoxies, or any other suitable thermoset material.

In addition, as mentioned, the thermoplastic and/or the thermoset material as described herein may optionally be reinforced with a fiber material, including but not limited to glass fibers, carbon fibers, polymer fibers, wood fibers, bamboo fibers, ceramic fibers, nanofibers, metal fibers, or similar or combinations thereof. In addition, the direction of the fibers may include multi-axial, unidirectional, biaxial, triaxial, or any other another suitable direction and/or combinations thereof. Further, the fiber content may vary depending on the stiffness required in the corresponding blade component, the region or location of the blade component in the rotor blade 16, and/or the desired weldability of the component.

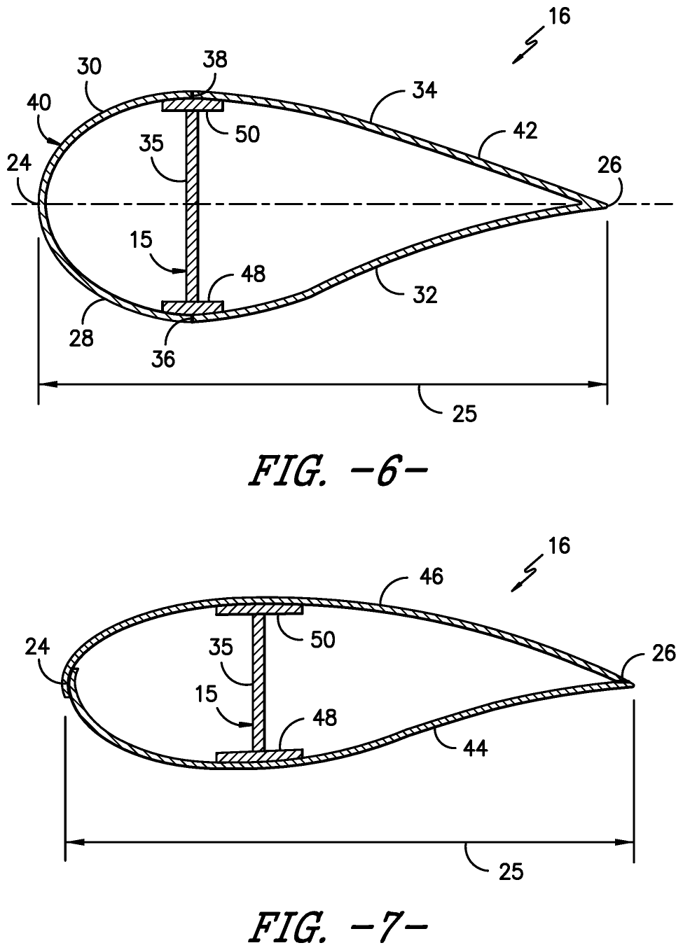

More specifically, as shown, the main blade structure 15 may include any one of or a combination of the following: a pre-formed blade root section 20, a pre-formed blade tip section 22, one or more one or more continuous spar caps 48, 50, 51, 53, one or more shear webs 35 (FIGS. 6-7), an additional structural component 52 secured to the blade root section 20, and/or any other suitable structural component of the rotor blade 16. Further, the blade root section 20 is configured to be mounted or otherwise secured to the rotor 18 (FIG. 1). In addition, as shown in FIG. 2, the rotor blade 16 defines a span 23 that is equal to the total length between the blade root section 20 and the blade tip section 22. As shown in FIGS. 2 and 6, the rotor blade 16 also defines a chord 25 that is equal to the total length between a leading edge 24 of the rotor blade 16 and a trailing edge 26 of the rotor blade 16. As is generally understood, the chord 25 may generally vary in length with respect to the span 23 as the rotor blade 16 extends from the blade root section 20 to the blade tip section 22.

Referring particularly to FIGS. 2-4, any number of blade segments 21 or panels (also referred to herein as blade shells) having any suitable size and/or shape may be generally arranged between the blade root section 20 and the blade tip section 22 along a longitudinal axis 27 in a generally span-wise direction. Thus, the blade segments 21 generally serve as the outer casing/covering of the rotor blade 16 and may define a substantially aerodynamic profile, such as by defining a symmetrical or cambered airfoil-shaped cross-section. In additional embodiments, it should be understood that the blade segment portion of the blade 16 may include any combination of the segments described herein and are not limited to the embodiment as depicted. In addition, the blade segments 21 may be constructed of any suitable materials, including but not limited to a thermoset material or a thermoplastic material optionally reinforced with one or more fiber materials. More specifically, in certain embodiments, the blade segments 21 may include any one of or combination of the following: pressure and/or suction side segments 44, 46, (FIGS. 2 and 3), leading and/or trailing edge segments 40, 42 (FIGS. 2-6), a non-jointed segment, a single-jointed segment, a multi-jointed blade segment, a J-shaped blade segment, or similar.

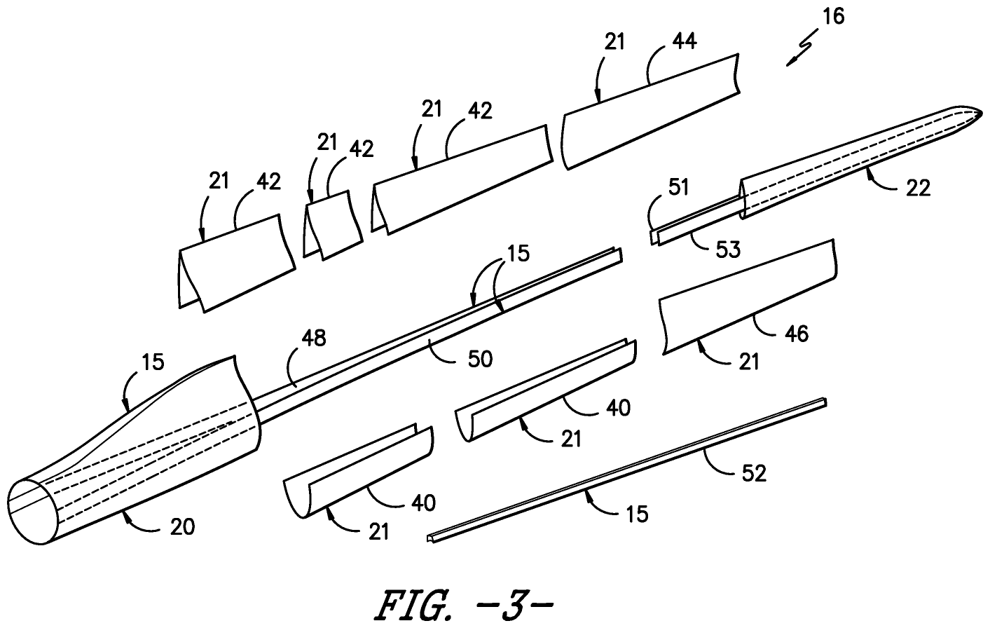

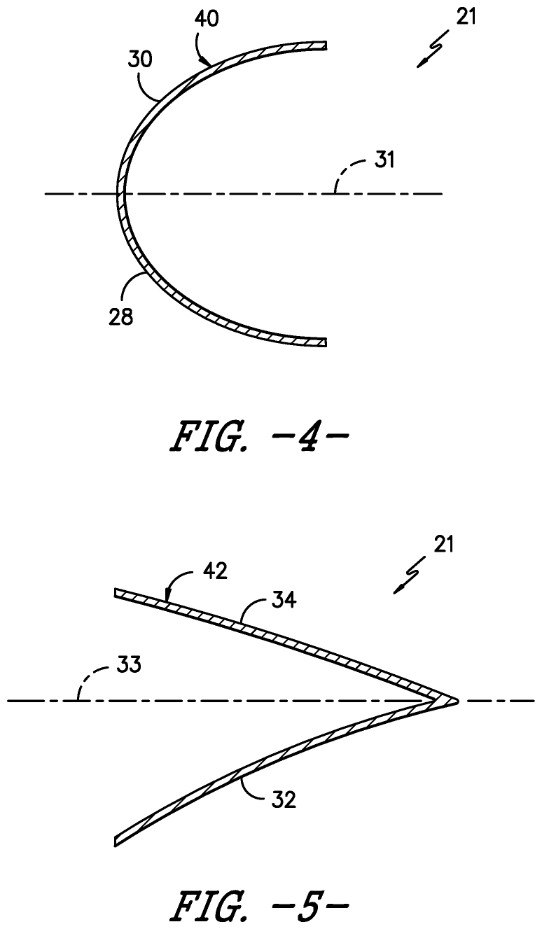

More specifically, as shown in FIG. 4, the leading edge segments 40 may have a forward pressure side surface 28 and a forward suction side surface 30. Similarly, as shown in FIG. 5, each of the trailing edge segments 42 may have an aft pressure side surface 32 and an aft suction side surface 34. Thus, the forward pressure side surface 28 of the leading edge segment 40 and the aft pressure side surface 32 of the trailing edge segment 42 generally define a pressure side surface of the rotor blade 16. Similarly, the forward suction side surface 30 of the leading edge segment 40 and the aft suction side surface 34 of the trailing edge segment 42 generally define a suction side surface of the rotor blade 16. In addition, as particularly shown in FIG. 6, the leading edge segment(s) 40 and the trailing edge segment(s) 42 may be joined at a pressure side seam 36 and a suction side seam 38. For example, the blade segments 40, 42 may be configured to overlap at the pressure side seam 36 and/or the suction side seam 38. Further, as shown in FIG. 2, adjacent blade segments 21 may be configured to overlap at a seam 54. Thus, where the blade segments 21 are constructed at least partially of a thermoplastic material, adjacent blade segments 21 can be welded together along the seams 36, 38, 54, which will be discussed in more detail herein. Alternatively, in certain embodiments, the various segments of the rotor blade 16 may be secured together via an adhesive (or mechanical fasteners) configured between the overlapping leading and trailing edge segments 40, 42 and/or the overlapping adjacent leading or trailing edge segments 40, 42.

In specific embodiments, as shown in FIGS. 2-3 and 6-7, the blade root section 20 may include one or more longitudinally extending spar caps 48, 50 infused therewith. For example, the blade root section 20 may be configured according to U.S. application Ser. No. 14/753,155 filed Jun. 29, 2015 entitled “Blade Root Section for a Modular Rotor Blade and Method of Manufacturing Same” which is incorporated herein by reference in its entirety.

Similarly, the blade tip section 22 may include one or more longitudinally extending spar caps 51, 53 infused therewith. More specifically, as shown, the spar caps 48, 50, 51, 53 may be configured to be engaged against opposing inner surfaces of the blade segments 21 of the rotor blade 16. Further, the blade root spar caps 48, 50 may be configured to align with the blade tip spar caps 51, 53. Thus, the spar caps 48, 50, 51, 53 may generally be designed to control the bending stresses and/or other loads acting on the rotor blade 16 in a generally span-wise direction (a direction parallel to the span 23 of the rotor blade 16) during operation of a wind turbine 10. In addition, the spar caps 48, 50, 51, 53 may be designed to withstand the span-wise compression occurring during operation of the wind turbine 10. Further, the spar cap(s) 48, 50, 51, 53 may be configured to extend from the blade root section 20 to the blade tip section 22 or a portion thereof. Thus, in certain embodiments, the blade root section 20 and the blade tip section 22 may be joined together via their respective spar caps 48, 50, 51, 53.

In addition, the spar caps 48, 50, 51, 53 may be constructed of any suitable materials, e.g. a thermoplastic or thermoset material or combinations thereof. Further, the spar caps 48, 50, 51, 53 may be pultruded from thermoplastic or thermoset resins. As used herein, the terms “pultruded,” “pultrusions,” or similar generally encompass reinforced materials (e.g. fibers or woven or braided strands) that are impregnated with a resin and pulled through a stationary die such that the resin cures or undergoes polymerization. As such, the process of manufacturing pultruded members is typically characterized by a continuous process of composite materials that produces composite parts having a constant cross-section. Thus, the pre-cured composite materials may include pultrusions constructed of reinforced thermoset or thermoplastic materials. Further, the spar caps 48, 50, 51, 53 may be formed of the same pre-cured composites or different pre-cured composites. In addition, the pultruded components may be produced from rovings, which generally encompass long and narrow bundles of fibers that are not combined until joined by a cured resin.

Referring to FIGS. 6-7, one or more shear webs 35 may be configured between the one or more spar caps 48, 50, 51, 53. More particularly, the shear web(s) 35 may be configured to increase the rigidity in the blade root section 20 and/or the blade tip section 22. Further, the shear web(s) 35 may be configured to close out the blade root section 20.

In addition, as shown in FIGS. 2 and 3, the additional structural component 52 may be secured to the blade root section 20 and extend in a generally span-wise direction so as to provide further support to the rotor blade 16. For example, the structural component 52 may be configured according to U.S. application Ser. No. 14/753,150 filed Jun. 29, 2015 entitled “Structural Component for a Modular Rotor Blade” which is incorporated herein by reference in its entirety. More specifically, the structural component 52 may extend any suitable distance between the blade root section 20 and the blade tip section 22. Thus, the structural component 52 is configured to provide additional structural support for the rotor blade 16 as well as an optional mounting structure for the various blade segments 21 as described herein. For example, in certain embodiments, the structural component 52 may be secured to the blade root section 20 and may extend a predetermined span-wise distance such that the leading and/or trailing edge segments 40, 42 can be mounted thereto.

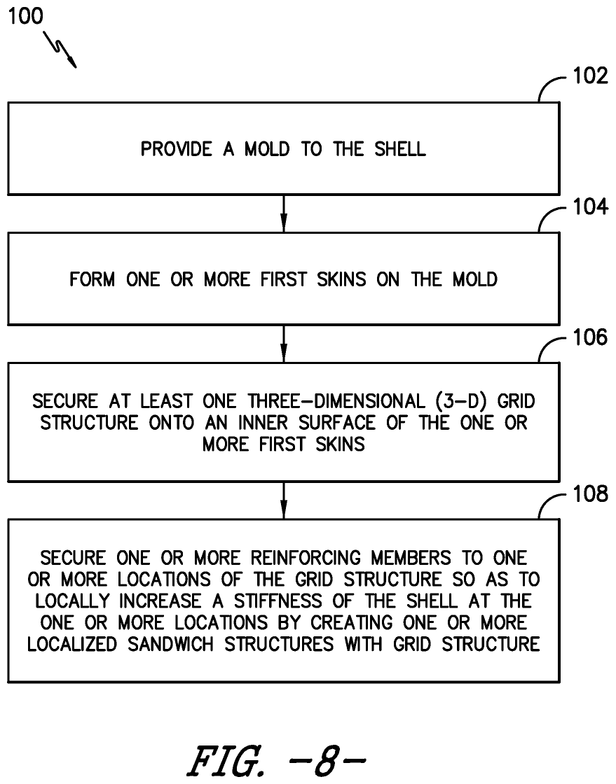

Referring now to FIG. 8, the present disclosure is directed to methods for manufacturing a shell, such as the rotor blade shells 21 described herein, having at least one grid structure 62. More specifically, as shown, a flow diagram of one embodiment of a method 100 for manufacturing a shell according to the present disclosure is illustrated. As such, in certain embodiments, the shell may correspond to the rotor blade shell 21 described herein and may thus include a pressure side shell, a suction side shell, a trailing edge segment, a leading edge segment, or combinations thereof. However, it should be appreciated that the disclosed method 100 may be used to manufacture any other shells in addition to rotor blade shells. In addition, although FIG. 8 depicts steps performed in a particular order for purposes of illustration and discussion, the methods described herein are not limited to any particular order or arrangement. One skilled in the art, using the disclosures provided herein, will appreciate that various steps of the methods can be omitted, rearranged, combined and/or adapted in various ways.

As shown at (102), the method 100 includes providing a mold 58 of the shell 21. As shown at (104), the method 100 includes forming one or more first skins 56 on the mold 58. In an embodiment, it should be understood that the first skins 56 may be curved. In such embodiments, the method 100 may include forming the curvature of the first skins 56. Such forming may include providing one or more generally flat fiber-reinforced outer skins, forcing the first skins 56 into a desired shape corresponding to a desired contour, and maintaining the first skins 56 in the desired shape during printing and depositing. As such, the first skins 56 generally retain their desired shape when the first skins 56 and the grid structure 62 secured thereto (described below) are released.

As shown in FIG. 9, a side view of one embodiment of the mold 58 is illustrated. Further, as shown, the first skins 56 may be formed atop the mold 58. In certain embodiments, the first skin(s) 56 may also be optionally reinforced with various fiber materials. For example, in one embodiment, the first skin(s) 56 may include one or more continuous, multi-axial (e.g. biaxial) fiber-reinforced thermoplastic or thermoset skins. Further, in particular embodiments, the method of forming the fiber-reinforced first skins 56 may include at least one of injection molding, 3-D printing, 2-D pultrusion, 3-D pultrusion, thermoforming, vacuum forming, pressure forming, bladder forming, automated fiber deposition, automated fiber tape deposition, or vacuum infusion.

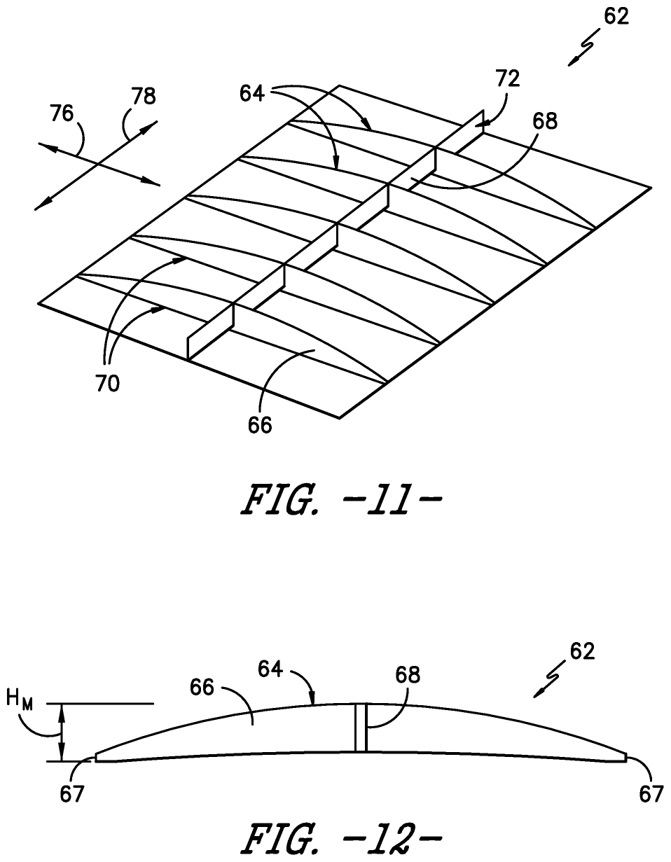

Referring back to FIG. 8, as shown at (106), the method 100 further includes securing at least one three-dimensional (3-D) grid structure 62 onto an inner surface of the first skin(s) 56. For example, as shown in FIG. 11, the grid structure 62 may be formed of a plurality of intersecting rib members 64. More specifically, as shown, the rib members 64 may include, at least, one or more first rib members 66 extending in a first direction 76 and one or more second rib members 68 extending in a different, second direction 78. In several embodiments, as shown, the first direction 76 of the first set 70 of rib members 64 may be generally perpendicular to the second direction 78. In still further embodiments, as shown in FIG. 12, the grid structure 62 may define a maximum height (e.g. H_{M}) that tapers from opposing sides of the maximum height H_{M} to a minimum height at each edge 67 of the grid structure 62. More specifically, as shown, the grid structure 62 may taper towards the inner surface of the first skins 56. Such tapering may correspond to certain blade locations requiring more or less structural support or may be provided due to size restrictions (such as at the trailing edge of the rotor blade). In further embodiments, the rib members 64 may be shorter at or near the blade tip and may increase as the grid structure 62 approaches the blade root. It should be understood that a slope of the tapering end(s) may be linear or non-linear. In such embodiments, the tapering end(s) provide an improved stiffness versus weight ratio of the panel 21.

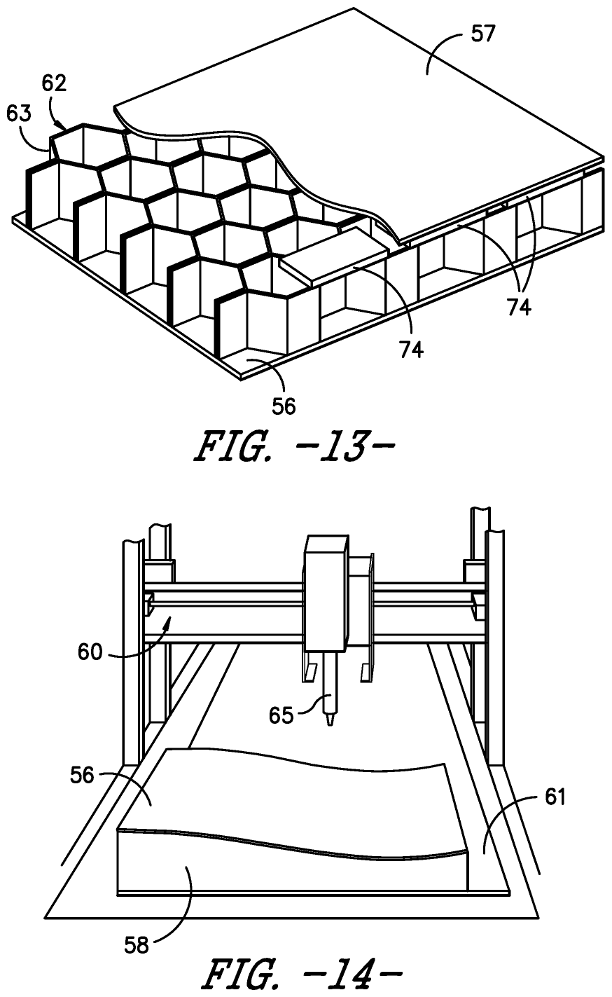

It should be understood that the grid structure 62 can be formed to have any suitable shape and/or configuration. For example, in another embodiment, as shown in FIG. 13, the grid structure 62 may include a core material, such as a honeycomb configuration 63. Moreover, in further embodiments, it should be understood that the core material described herein can be any structure that is cellular in nature, closed or open cell, that is intended to fill a volume to minimize material use and weight while also strong and stiff enough to carry required loads between the surfaces the core material is mounted to. As such, the core materials described herein may be made from natural (i.e. wood, balsa) or synthetic (i.e. thermoplastic) materials. In addition, the core materials can be made from foamed materials where the cells are voids in the material or made from dense materials in patterns (such as a honeycomb hexagonal structure). Provided the core material can be secured to both the reinforcing member and the skin in the localized area of interest and can provide sufficient load carrying capability between the skin and the reinforcing member at an acceptable weight for the design, the core material(s) can be used to locally support the grid structure 62. In still further embodiments, the reinforcing member length and width may be extended to go over the grid structure(s) 62 on the surrounding edges such that the edges can be bonded to better tie in to the surrounding grid structure 62.

As such, depending on the desired stiffness of the grid structure 62 and/or the location therefore, the method 100 may include forming the grid structure(s) 62 using various manufacturing methods. For example, in one embodiment, the method 100 may include forming the grid structure(s) 62 via additive manufacturing, such as 3-D printing. 3-D printing, as used herein, is generally understood to encompass processes used to synthesize three-dimensional objects in which successive layers of material are formed under computer control to create the objects. As such, objects of almost any size and/or shape can be produced from digital model data. It should further be understood that the methods of the present disclosure are not limited to 3-D printing, but rather, may also encompass more than three degrees of freedom such that the printing techniques are not limited to printing stacked two-dimensional layers, but are also capable of printing curved shapes.

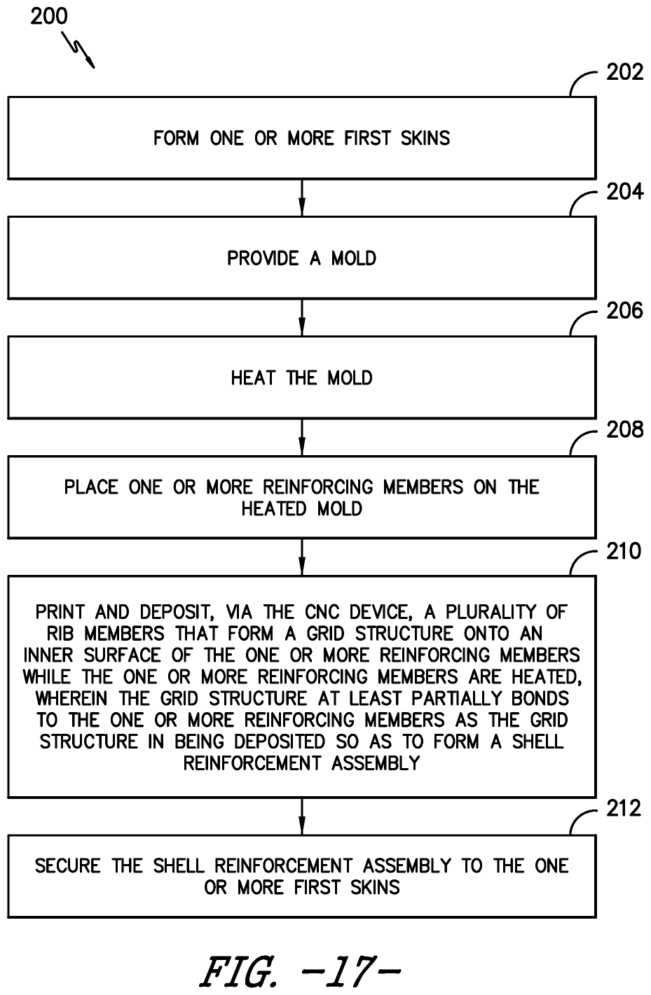

More specifically, in such embodiments, as shown in FIGS. 14-16, the method 100 may include placing the mold 58 of the rotor blade shell 21 relative to a computer numeric control (CNC) device 60, such as into a bed 61 of the CNC device 60. Alternatively, the method 100 may include placing the mold 58 under the CNC device 60 or adjacent the CNC device 60. Thus, the method 100 may also include printing and depositing, via the CNC device 60, the plurality of rib members 64 that form the grid structure 62 directly onto the inner surface of the first skin(s) 56 before the first skins 56 have cooled from forming. As such, the grid structure 62 may bond to the first skin(s) 56 as the grid structure 62 is being deposited, which eliminates the need for additional adhesive and/or curing time.

For example, in one embodiment, the CNC device 60 is configured to print and deposit the rib members 64 onto the inner surface of the one or more fiber-reinforced first skin(s) 56 after the formed skin(s) 56 reach a desired state that enables bonding of the printed rib members 64 thereto, i.e. based on one or more parameters of temperature, time, and/or hardness. Therefore, in certain embodiments, wherein the skin(s) 56 and the grid structure 62 are formed of a thermoplastic matrix, the CNC device 60 may immediately print the rib members 64 thereto as the forming temperature of the skin(s) 56 and the desired printing temperature to enable thermoplastic welding/bonding can be the same).

More specifically, in particular embodiments, before the skin(s) 56 have cooled from forming, (i.e. while the skins are still hot or warm), the CNC device 60 is configured to print and deposit the rib members 64 onto the inner surface of the one or more fiber-reinforced first skins 56. For example, in one embodiment, the CNC device 60 is configured to print and deposit the rib members 64 onto the inner surface of the first skins 56 before the skins 56 have completely cooled. In addition, in another embodiment, the CNC device 60 is configured to print and deposit the rib members 64 onto the inner surface of the first skin(s) 56 when the skins 56 have partially cooled. Thus, suitable materials for the grid structure 62 and the first skins 56 can be chosen such that the grid structure 62 bonds to the first skins 56 during deposition. Accordingly, the grid structure 62 described herein may be printed using the same materials or different materials.

For example, in one embodiment, a thermoset material may be infused into the fiber material on the mold 58 to form the first skins 56 using vacuum infusion. As such, the vacuum bag is removed after curing and the one or more thermoset grid structures 62 can then be printed onto the inner surface of the skins 56. Alternatively, the vacuum bag may be left in place after curing. In such embodiments, the vacuum bag material can be chosen such that the material would not easily release from the cured thermoset fiber material. Such materials, for example, may include a thermoplastic material such as polymethyl methacrylate (PMMA) or polycarbonate film. Thus, the thermoplastic film that is left in place allows for bonding of thermoplastic grid structures 62 to the thermoset skins with the film in between.

In still further embodiments, the first skin(s) 56 may be formed of a reinforced thermoplastic resin with the grid structure 62 being formed of a thermoset-based resin with optional fiber reinforcement. In such embodiments, depending on the thermoset chemistry involved-the grid structure 62 may be printed to the first skin(s) 56 while the skins 56 are still hot, warm, partially cooled, or completely cooled.

In addition, the methods of the present disclosure may include treating the first skin(s) 56 to promote bonding between the first skin(s) 56 and the grid structure 62. More specifically, in certain embodiments, the first skin(s) 56 may be treated using flame treating, plasma treating, chemical treating, chemical etching, mechanical abrading, embossing, elevating a temperature of at least areas to be printed on the first skin(s) 56, and/or any other suitable treatment method to promote said bonding. In additional embodiments, the method may include forming the first skin(s) 56 with more (or even less) matrix resin material on the inside surface to promote said bonding. In additional embodiments, the method may include varying the outer skin thickness and/or fiber content, as well as the fiber orientation.

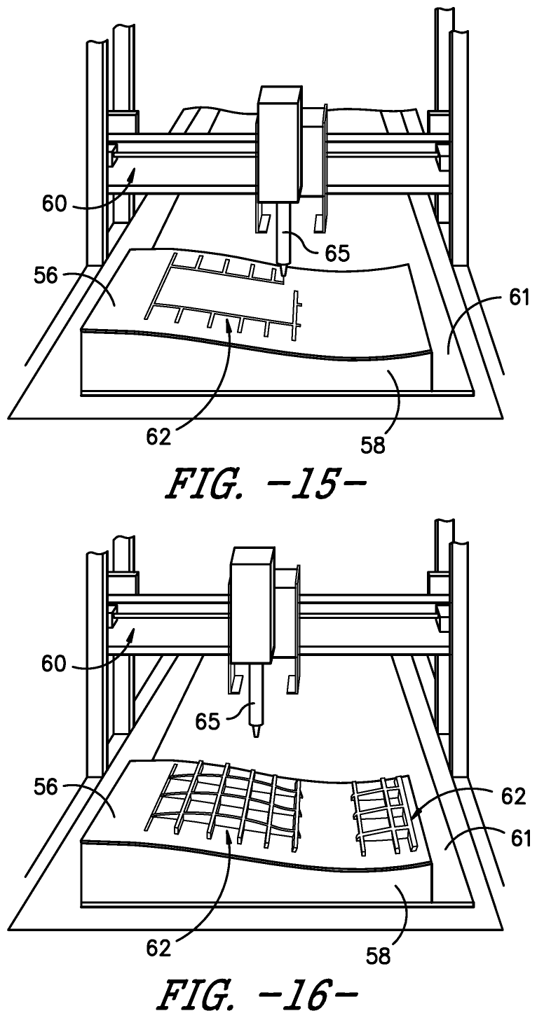

Accordingly, the method 100 of the present disclosure can also include varying the design of the grid structure 62 (e.g. materials, width, height, thickness, shapes, etc., or combinations thereof) to match a desired stiffness of the shell. As such, the grid structure 62 may define any suitable shape so as to form any suitable reinforcement component for the shell 21. For example, as shown in FIG. 15, the CNC device 60 may begin printing the grid structure 62 by first printing an outline of the structure 62 and building up the grid structure 62 with the rib members 64 in multiple passes. As such, one or more extruders 65 of the CNC device 60 can be designed having any suitable thickness or width so as to disperse a desired amount of resin material to create the rib members 64 with varying heights and/or thicknesses. Further, the grid size can be designed to allow local buckling of the face sheet in between the rib members 64, which can influence the aerodynamic shape as an extreme (gust) load mitigation device.

In several embodiments, the cycle time of printing the grid structure 62 can also be reduced by using a rib pattern that minimizes the amount of directional change. For example, 45-degree angled grids can likely be printed faster than 90-degree grids relative to the chord direction of the proposed printer, for example. As such, the present disclosure minimizes printer acceleration and deceleration where possible while still printing quality grid structures 62.

In alternative embodiments, rather than printing the grid structure 62, the grid structure 62 may be formed of a prefabricated core material having the honeycomb configuration (or similar) described herein with respect to FIG. 13. In such embodiments, the grid structure 62 may be bonded to the inner surface of the fiber-reinforced first skin(s) 56 (rather than joined during the printing process).

Referring back to FIG. 8, as shown at (108), the method 100 further includes securing one or more reinforcing members 74 to one or more locations of the grid structure 62 so as to locally increase a stiffness of the shell at the one or more locations by creating one or more localized sandwich structures with the grid structure 62. As used herein, a reinforcing member generally encompasses a reinforcing component or structure constructed of one or more optionally-fiber-reinforced layers of similar or dissimilar resin materials (such as composites) that are permanently bonded or otherwise secured together.

For example, as shown in FIGS. 9, 10, and 13, one or more reinforcing members 74 may be placed atop one or more locations of the grid structure(s) 62. More specifically, as shown particularly in FIG. 9, the method 100 may include placing the reinforcing member(s) 74 at one or more locations of the grid structure 62 corresponding to, for example, a center location of the shell, a trailing edge of the shell, or one or more locations having a load above a predetermined threshold. In further embodiments, determining the location(s) having the load above the predetermined threshold may include performing, for example, a computer-implemented structural analysis on the shell.

As such, the reinforcing members 74 may be efficiently placed at any suitable location that may otherwise be difficult to provide additional reinforcement to the grid structure 62. For example, in some areas of the rotor blade (such as near the trailing edge), the grid structure 62 cannot be made taller because of space limitations. Thus, the reinforcing member(s) 74 can be placed in the grid structure 62 at such locations to improve stiffness without requiring a taller grid structure. Such reinforcing member(s) 74 can generally be more weight and/or cost efficient than without. This can be especially true in areas of the rotor blade that have higher loading as very tall grid structures will be less weight efficient versus adding the reinforcing members to particular locations of the grid structure 62.

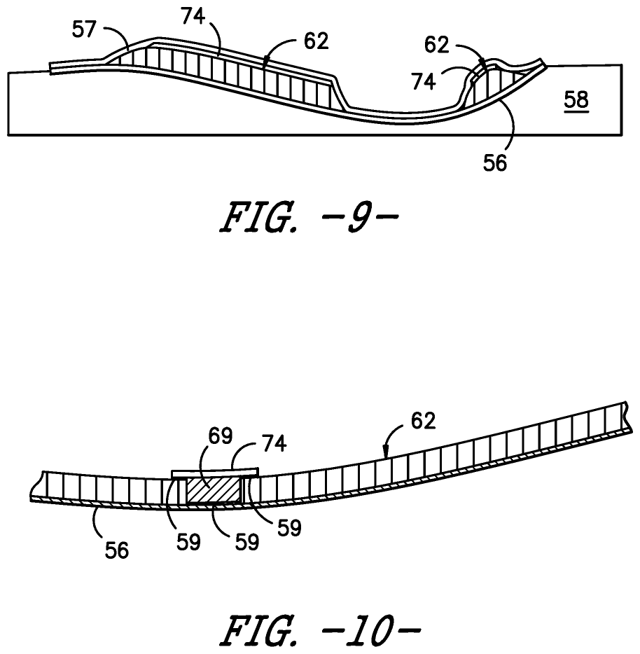

In addition, as shown particularly in FIG. 10, the reinforcing member(s) 74 may be secured to a core material 69 that is positioned within or on top of the grid structure 62. The core material 69 may include any suitable core material, for example, such as the core material(s) described herein with respect to core material 63. As such, the reinforcing member(s) 74 with the core material 69 attached thereto may be secured to the inner surface of the one or more first skins 56, e.g. via adhesive 59. Accordingly, in such embodiments, the combination of the reinforcing member(s) 74 and the core material 69 (rather than just a single layer) provides increased rigidity.

In additional embodiments, the method 100 may include securing the reinforcing member(s) 74 to various location(s) of the grid structure 62 via adhesive bonding (as mentioned), thermoplastic welding, ultrasonic welding, tack welding, laser welding, chemical welding, hot plate welding, and/or combinations thereof.

In further embodiments, the method 100 may also include securing one or more second skins 57 to the reinforcing member(s) 74 so as to form the rotor blade shell 21. It should be understood that the one or more second skins 57 can be configured and formed similar or identical to the one or more first skins 56 described herein. Further, FIG. 9 illustrates one embodiment of the second skin(s) 57 placed atop the first skin(s) 56, the grid structures 62, and the corresponding reinforcing members 74 so as to form the shell 21. Accordingly, as shown in the illustrated embodiment, the grid structure 62 and the reinforcing member(s) 74 may be sandwiched between the first and second skins 56, 57 and can be placed at strategic locations in the blade shell needed increased strength or stiffness.

In further embodiments, the method 100 may include securing at least a portion of the grid structure(s) 62 to the first skin(s) 56 and/or the second skin(s) 57. In particular embodiments, the method 100 may include printing the grid structure 62 such that a first side of the grid structure 62 bonds directly to the first skin(s) 56. In such embodiments, the method 100 may also include bonding a second side of the grid structure 62 to the second skin(s) 57 via an adhesive.

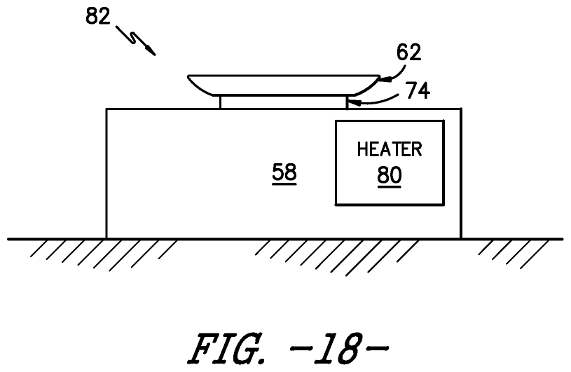

Referring now to FIG. 17, a flow diagram of another embodiment of a method 200 for manufacturing a shell according to the present disclosure is illustrated. In general, the method 200 is described herein as implemented for manufacturing rotor blade shells 21 described above. However, it should be appreciated that the disclosed method 200 may be used to manufacture any other shell components. In addition, although FIG. 17 depicts steps performed in a particular order for purposes of illustration and discussion, the methods described herein are not limited to any particular order or arrangement. One skilled in the art, using the disclosures provided herein, will appreciate that various steps of the methods can be omitted, rearranged, combined and/or adapted in various ways.

As shown at (202), the method 200 includes forming one or more first 56, such as via vacuum forming or additive manufacturing. As shown at (204), the method 200 includes providing a mold 58. In one embodiment, for example, the mold 58 could be a linear flat mold, as shown in FIG. 18.

Referring back to FIG. 17, as shown at (206), the method 200 includes heating the mold. For example, the mold 58 may be equipped with a heater 80 for heating a surface of the mold 58. As shown at (208), the method 200 includes placing one or more reinforcing members 74 on the heated mold 58. As shown at (210), the method 200 includes printing and depositing, via the CNC device 60, the grid structure 62 onto an inner surface of the one or more reinforcing members 74 while the one or more reinforcing members 74 are heated. Thus, in such embodiments, as shown in FIG. 18, the grid structure 62 may at least partially bond to the one or more reinforcing members 74 as the grid structure 62 is being deposited so as to form a shell reinforcement assembly 82. Accordingly, referring back to FIG. 17, as shown at (212), the method 200 includes securing the shell reinforcement assembly 82 to the one or more fiber-reinforced first skins 56.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A method for manufacturing a shell, the method comprising:
providing a mold of the shell;
forming one or more first skins on the mold;
securing at least one three-dimensional (3-D) grid structure onto an inner surface of the one or more first skins; and
securing one or more reinforcing members to one or more locations of the grid structure so as to locally increase a stiffness of the shell at the one or more locations by creating one or more localized sandwich structures with the grid structure.

2. The method of claim 1, wherein securing the at least one 3-D grid structure onto the inner surface of the one or more first skins further comprises:
placing the mold of the shell relative to a computer numeric control (CNC) device; and,
printing and depositing, via the CNC device, the grid structure onto the inner surface of the one or more first skins before the one or more first skins have cooled from forming, the grid structure bonding to the one or more first skins as the grid structure is being deposited.

3. The method of claim 1, wherein the one or more locations of the grid structure correspond to at least one of a center location of the shell, a trailing edge of the shell, or one or more locations having a load above a predetermined threshold.

4. The method of claim 3, further comprising determining the one or more locations having the load above the predetermined threshold by performing a computer-implemented structural analysis on the shell.

5. The method of claim 1, wherein securing the at least one 3-D grid structure onto the inner surface of the one or more first skins further comprises:
forming the grid structure of a core material; and,
securing the grid structure to the inner surface of the one or more first skins.

6. The method of claim 1, wherein securing the one or more reinforcing members to one or more locations of the grid structure further comprises:
securing the one or more reinforcing members to a core material; and,
securing at least a portion of the one or more reinforcing members and/or the core material to the inner surface of the one or more first skins.

7. The method of claim 1, further comprising securing the one or more reinforcing members to the one or more locations of the grid structure via at least one of adhesive bonding, thermoplastic welding, ultrasonic welding, tack welding, laser welding, chemical welding, hot plate welding, and/or combinations thereof.

8. The method of claim 1, wherein the one or more reinforcing members are constructed of at least one of laminate, polymer, metal, wood, fibers, or combinations thereof.

9. The method of claim 1, further comprising bonding one or more second skins to at least one of the one or more reinforcing members of the one or more first skins.

10. The method of claim 9, further comprising securing at least a portion of the grid structure to at least one of the one or more first skins or the one or more second skins.

11. A shell, comprising:
one or more fiber-reinforced first skins;
at least one shell reinforcement assembly secured to the one or more fiber-reinforced first skins, the at least one shell reinforcement assembly comprising:
at least one three-dimensional (3-D) grid structure; and,
one or more reinforcing members secured to one or more locations of the grid structure so as to locally increase a stiffness of the shell at the one or more locations by creating one or more localized sandwich structures with the grid structure.

12. The shell of claim 11, wherein at least one of the grid structure or the one or more reinforcing members comprises a core material.

13. The shell of claim 11, wherein the one or more locations of the grid structure correspond to at least one of a center location of the shell, a trailing edge of the shell, or one or more locations having a load above a predetermined threshold.

14. The shell of claim 11, wherein the one or more reinforcing members are secured to the one or more locations of the grid structure via at least one of adhesive bonding, thermoplastic welding, ultrasonic welding, tack welding, laser welding, chemical welding, hot plate welding, and/or combinations thereof.

15. The shell of claim 11, wherein the one or more reinforcing members are constructed of at least one of laminate, polymer, metal, wood, fibers, or combinations thereof.

16. The shell of claim 11, further comprising one or more second skins bonded to at least one of the one or more reinforcing members of the one or more first skins.

17. A method for manufacturing a shell, the method comprising:
forming one or more first skins;
providing a mold;
heating the mold;
placing one or more reinforcing members on the heated mold;
printing and depositing, via the CNC device, a plurality of rib members that form a grid structure onto an inner surface of the one or more reinforcing members while the one or more reinforcing members are heated, wherein the grid structure at least partially bonds to the one or more reinforcing members as the grid structure is being deposited so as to form a shell reinforcement assembly; and,
securing the shell reinforcement assembly to the one or more first skins.

18. The method of claim 17, further comprising forming the one or more first skins via vacuum forming or additive manufacturing.

19. The method of claim 17, further comprising securing at least a portion of the grid structure to the one or more first skins.

20. The method of claim 17, wherein the one or more reinforcing members are constructed of at least one of laminate, polymer, metal, fibers, wood, or combinations thereof.
